(19) United States
(12) Patent Application Publication
(10) Pub. No.: US 2004/0205515 A1
(43) Pub. Date: Oct. 14, 2004

(54) Multi-media story editing tool

(75) Inventors: Seth Louis Socolow, San Francisco, CA (US); Joseph Bassi, Los Altos, CA (US)

Correspondence Address: MICHAEL J. BUCHENHORNER, ESQ, HOLLAND & KNIGHT, 701 BRICKELL AVENUE, MIAMI, FL, 33131, US

(73) Assignee: Simple Twists, Ltd.

(21) Appl. No.: 10/411,029

(22) Filed: Apr. 10, 2003

(51) Int. Cl. G06F 15/00

(52) U.S. Cl. 715/501.1

(57) ABSTRACT

A method for: creating a presentation of a story comprises the steps of: displaying a screen comprising a representation of a timeline relating to a story wherein the representation comprises a plurality of points, each for representing an event; receiving information relating to at least one event and a time associated with the event; storing the received information in association with the at least one event; and linking the information to at least one point in the representation such that a user can retrieve the information by selecting the at least one point; the method is also for creating a production using a timeline file; and presenting the production according to the timeline file.

### CROSS-REFERENCE TO RELATED APPLICATIONS

None.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

None.

### FIELD OF THE INVENTION

The invention disclosed broadly relates to the field of interactive software, and more particularly relates to the field of creating multimedia productions using interactive software.

### BACKGROUND OF THE INVENTION

Today, in the digital age, more and more software products are being created and sold which assist people with creating stories for presentation to others, such as personalized web sites with features such as digital images. These software tools allow a user to add elaborate enhancements to a web site, such as streaming video. The availability of products such as digital cameras, scanners and MP3 (MPeg Audio Layer 3) devices has enabled today's home computer to become the hub of a family's multimedia productions. The drawback is that the products require a level of computer knowledge and experience that is above the comfort zone of the novice or occasional computer user.

Screenwriters can use text-editing software to help them write their stories in text-only format. But in order to build and present a story with images and sounds, more sophisticated tools are required. These tools are available in various software products including photo editors, storyboard editors, sound editing tools, video editors, and presentation tools, etc. The drawback to these specialized tools is twofold: first, the specialized software product may be “overkill” for the average user. A user who needs a photo editing tool merely to crop a photo and add a caption to that photo will find little use for most of the features in a specialized photo editing software product.

Second, the specialized nature of these products limits their use to one or two specific features, necessitating the use of two, three, or more products in order to build a multimedia story. Each additional product not only increases the expense involved, but it creates an additional burden to the user who must learn how to use these varied and complex tools.

While more and more writers are turning to software products to help them write stories, there is a need for a comprehensive, user-friendly software product which helps a writer “build” a complete story, using text, sound, and images.

### SUMMARY OF THE INVENTION

Briefly, according to an invention claimed herein, a method for: creating a presentation of a story comprises the steps of: displaying a timeline relating to a story wherein the timeline comprises a plurality of points, each for representing an event; receiving information relating to at least one event and a time associated with the event; storing the received information in association with the at least one event; and linking the information to at least one point in the representation such that a user can retrieve the information by selecting the at least one point; the method is also for creating a production using a timeline file; and presenting the production according to the timeline file.

The following drawings will serve to further illustrate and explain the aspects of the invention.

### BRIEF DESCRIPTION OF THE DRAWINGS

FIG. 1 is a diagram of a timeline production system, according to an embodiment of the present invention.

FIG. 2 shows a display of the main user interface of the Timeline Maker, according to an embodiment of the present invention.

FIG. 3 is a flow diagram representation of the creation of a timeline creation system, according to an embodiment of the present invention.

FIG. 4 shows a close-up, or “zoomed-in” display of the dashboard portion of the Timeline Maker, according to an embodiment of the present invention.

FIG. 5 shows a display of the “Welcome” screen for the Timeline Maker, according to an embodiment of the invention.

FIG. 6 shows a display of the subject question for the Timeline Maker.

FIG. 7 shows a “Create New Event” dialog box, according to an embodiment of the invention.

FIG. 8 shows a display of the Interview dialog box, according to an embodiment of the invention.

FIG. 9 shows a display of the Event Music and Sounds dialog box, according to an embodiment of the invention.

FIG. 10 shows a display of the “Add Song or Sound to Event” box, according to an embodiment of the invention.

FIG. 11 shows a display of the “Browse” box, according to an embodiment of the invention.

FIG. 12 is a block diagram of the process of ripping a CD, according to an embodiment of the invention.

FIG. 13 is a representation of the process of selecting an image for the timeline, according to an embodiment of the invention.

FIG. 14 shows a display of the “Images and Memories” dialog box, according to an embodiment of the invention.

FIG. 15 shows a display of the “Add New Image to Event” box, according to an embodiment of the invention.

FIG. 16 shows a display of the “Videos and Memories” box, according to an embodiment of the invention.

FIG. 17 shows a display of the “Image Editor” dialog box, according to an embodiment of the invention.

FIG. 18 shows the Production Generator “Timewalker” wizard, according to an embodiment of the invention.

FIG. 19 shows a display of the Production Generator main user interface, according to an embodiment of the invention.

FIG. 20 shows an alternate embodiment of the Production Generator main user interface featuring the “Timewalker” wizard.

FIG. 21 shows a display of the Text Editor interface of the Production Generator, according to an embodiment of the invention.

FIG. 22 shows a display of the Music Editor interface of the Production Generator, according to an embodiment of the invention.

FIG. 23 shows a display of the Images Editor interface of the Production Generator, according to an embodiment of the invention.

FIG. 24 shows a display of the Video Editor interface of the Production Generator, according to an embodiment of the invention.

FIG. 25 shows a close-up view of the Place Holder Setting selection box in the Images Editor interface of FIG. 23, according to an embodiment of the invention.

FIG. 26 shows a Slide Properties editing interface, according to an embodiment of the invention.

FIG. 27 shows the zoom feature of the Production Generator, according to an embodiment of the invention.

FIG. 28 shows the Append New Slide interface, according to an embodiment of the invention.

FIG. 29 is a simplified block diagram of a computer program product on which an embodiment of the invention can be advantageously used.

### DETAILED DESCRIPTION OF PREFERRED EMBODIMENTS

According to an embodiment of the invention we discuss a user-friendly, interview-driven system for creating and displaying a multimedia production centered around a chosen subject or subjects. The subject can be a person, living or dead, fictitious or real; an animal; a cartoon; or an entity such as a company or other subjects that can be discussed across a time period. The subjects and uses for this system are limited only by a person's imagination. Some possible uses are in entertainment or as an educational tool. Since the system is easy to use, it could be used as an instructional aid in classrooms where children can use the system to create and display multimedia presentations about historical Figures. It could be implemented to pay tribute to someone, perhaps a deceased loved one. Another use would be to create a story about a couple to be presented as a wedding gift. In one embodiment of the invention, two separate timelines could be created which would “intersect” at a point in time to represent a wedding day.

A timeline is defined as a chronological listing of events. A timeline can be displayed horizontally or vertically. In the instant invention, the timeline is an organizational metaphor for grouping multimedia items related to events in a story. One aspect of the invention, the timeline maker, is an easy-to-use interface, geared for the individual with little or no computer expertise, which allows a user to create a story of a subject and enhance that story with a variety of multimedia tools. The story created by the timeline maker is output into a timeline file. A story, for purposes of this discussion, is a series of events that are preferably related in some way.

The timeline maker interacts with a user using a graphical user interface (GUI), called the “dashboard.” The dashboard is presented as a timeline in order to facilitate the arrangement of events in chronological order. The user first chooses a subject or subjects on which to base the story. Next, the user selects a beginning point for the story on the timeline by double-clicking on the timeline and entering the date or dates in the dialog box provided. The dashboard will automatically generate an end point on the timeline, which will be the current date. Once started in this manner, the dashboard will generate interview-driven GUIs in form of dialog boxes which guide the user in creating and enhancing parts of the story, known as “events.” The story could be about one subject, or possibly multiple subjects. The subject could be a person (real or fictitious), an animal or it could also be an entity such as a company. The story itself could span a lifetime, or a shorter time period, such as a vacation.

The story created in this manner can be as simple or as complex as the user desires. The dashboard has many built-in features which the user can choose as defaults. Assume that a user is creating a story about a subject born in the 1980s and would like to be reminded of songs from that time period to enhance the story. The user has several options, from allowing the dashboard to select from among pre-selected songs from that era (the default), to selecting music from a personal archive.

Just as a writer is rarely able to write a book in one sitting, it is unlikely that a user will be able to create a complete story in one sitting. The dashboard handles this by making it very easy to exit from and return to the timeline in order to create, modify and/or delete events in the story. The many GUIs are not only user-friendly, they are easy to exit, allowing for a user to quickly and easily finish part of the story, save it, and then return at a later time to work on the story. This feature makes this an attractive product for writers who may wish to start a story by recording events (scenes) and main characters on the timeline to sketch out a story, then over a period of time use the dashboard to add characters and events or “flesh out” (add detail to) the existing characters.

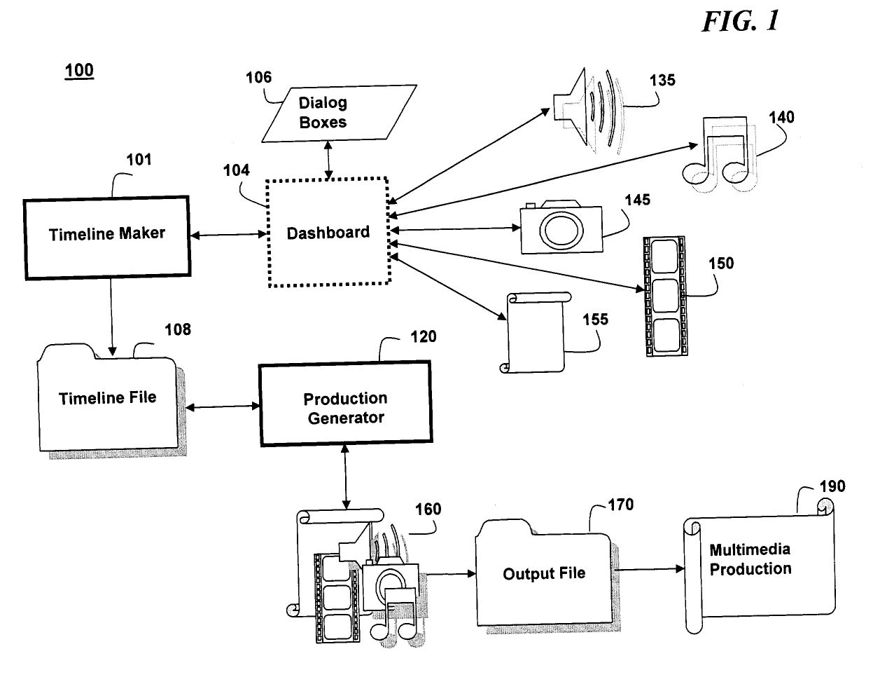

Referring to FIG. 1, there is shown a diagram of a timeline production system 100 for creating and outputting a story, according to an embodiment of the invention. The two main components of this system are the Timeline Maker 101 and the Production Generator 120. The Timeline Maker 101 is an interview-driven system in which a user can easily create a story about a subject or subjects by navigating through user-friendly dialog boxes to input information which will uniquely present or express the subject's story. In addition, textual and graphical images, digital images, photos, audio and video can be added to further enhance the story. The Production Generator 120 is a system whereby a multimedia production based on the story created with the Timeline Maker 101 can be created and presented. The production can be created in various formats, but for the purpose of this discussion, we will limit our examples to a slide presentation. According to an embodiment of the invention, the timeline comprises a combination of multimedia components either selected by the user or by the system based on general events, music, or images representative of the dates of the events included in the timeline file.

Timeline Maker

The Timeline Maker 101 implements a “Dashboard” 104 as the “driver” of the system. The Dashboard 104 is best described as a GUI which guides and assists a user in the creation of a timeline story. The Dashboard 104 implements a plurality of dialog boxes 106 which present a series of options, prompts and/or questions to the user. These dialog boxes 106 pop-up in response to a user's selection. The Dashboard 104 guides the user in creating a customized timeline story and also allows the user to enhance and further customize the story with the addition of a variety of multimedia effects geared to the subject's preferences, as input by the user. The multimedia effects can include audio 135, music 140, photo 145, video 150, and scanned input 155, as shown in FIG. 1. The Timeline Maker 101 receives input from the user in the form of text, audio, video and digital images and compiles the various media into a Timeline File 108. The Timeline Maker 101 creates the Timeline File 108 in a special file format similar to a database.

Once the user has created a story using the Timeline Maker 101 and is ready to present the story, the Production Generator 120 is activated. The Production Generator 120 creates an output format of the timeline story, using the Timeline File 108 as input, and optionally receives as input any further multimedia effects 160 which a user wishes to add to embellish the story, and outputs the timeline story for display, using the text, audio, and video and photo images to create a multimedia production. The Production Generator 120 then creates a specially formatted Output File 170. The Output File 170 created by the Production Generator 120 is used to present a Multimedia Production 190, which in a preferred embodiment will be formatted as a multimedia slide presentation. The Output File 170 can be created in a proprietary file format, or as an HTML (Hyper-Text Markup Language) file, or in any other format which would optimally facilitate a multimedia presentation. Optionally, the user can further customize the presentation before displaying it.

According to this embodiment, the Production Generator 120 presents a user with a production comprising images, text, music, voice-over, or video or a combination of any of these. The user can be prompted to customize the production or the Production Generator 120 can use its own selected multimedia components based on the events in the Timeline File 108. Optionally, the Production Generator can, at the user's request, present zoom versions of displayed images, a continuous song during the display of slides, and a voice-over while displaying the slides. The Production Generator 120 can also rotate images into various placeholders, either at a user's request or as a default.

As stated earlier, the Dashboard 104 drives the creation of the timeline story through the use of interview-driven dialog boxes 106. Some key features of the Dashboard 104 are:

ease of use;

interview-driven;

organize events chronologically;

zoom feature;

editing capabilities;

batch input media according to date stamp;

default features, such as pre-selected songs;

user interface elements can be customized.

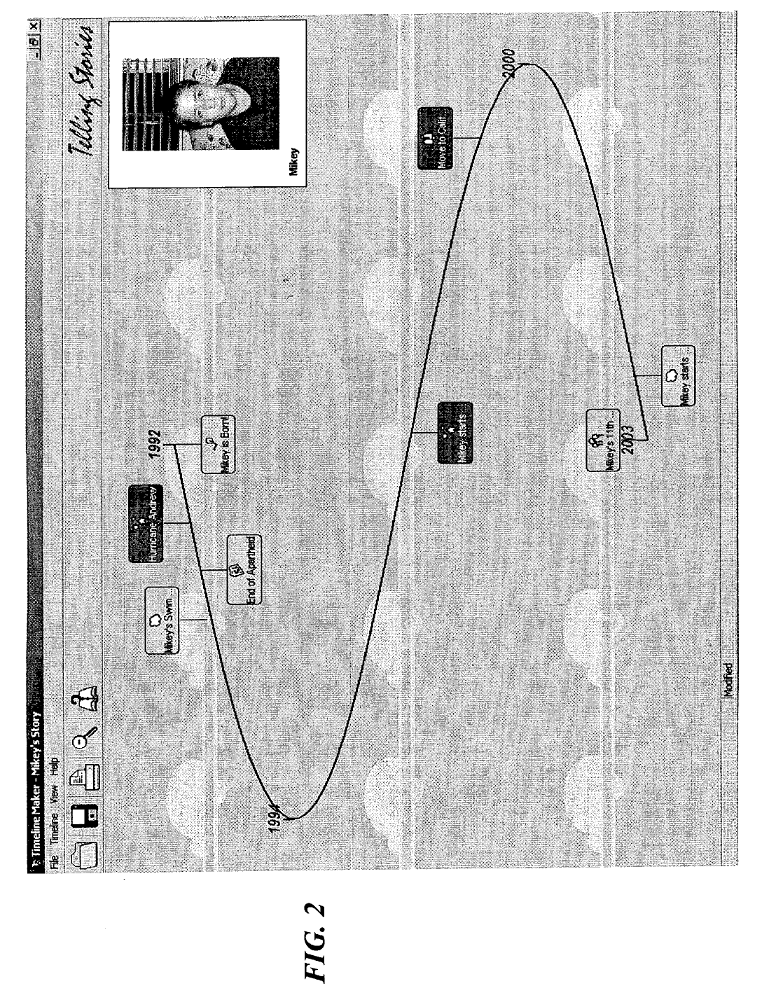

FIG. 2 shows a display of a preferred embodiment of the Timeline Dashboard 104. The Dashboard 104 allows the user to choose the length of new stories and also allows the user to associate all media with an event. It also provides a way of viewing what medium is associated with each event and also adding memories to the event as a whole. An important feature of this embodiment is associating events in a story with points on a timeline. The timeline itself can be displayed in several shapes. An “S” shape is shown as an example; however it is possible to represent the events in the story with other geometric shapes such as a line or any other shape that a user may select or create for the production. A timeline could be displayed in the shape of a skyline, a famous structure, such as the Golden Gate Bridge, or a mountain range, to name a few examples. It should be understood that other possible embodiments could display timelines in a number of different shapes and still be in keeping with the spirit and scope of the invention.

To better understand the concept of the timeline as an organizational metaphor, assume that the timeline is a line segment, or a line bounded by two points. The two points are the beginning and ending points. In between those two points are an infinite number of points on the line. In the timeline, each point on the timeline is correlated with a time period, in chronological order. Events, or parts of the story, are added by associating the events with points on the timeline, each event representing a time period corresponding to one component of the story, such as a significant date in a subject's life. The dates can be any dates of the user's choosing, provided that the ending point is later in time than the starting point. Using the timeline to build a story in this manner assures that the events which make up the story are in chronological order. In a preferred embodiment, events will be represented as icons surrounding the timeline, on alternate sides. In the embodiment shown in FIG. 2, the events are represented by icons in the shape of rectangles. Other shapes and/or Figures could be used to represent events. Different types of events could be represented by different icons. The icons are located in the proximity of an associated event. By “proximity” we mean any position that an ordinary observer would associate with the related event or time.

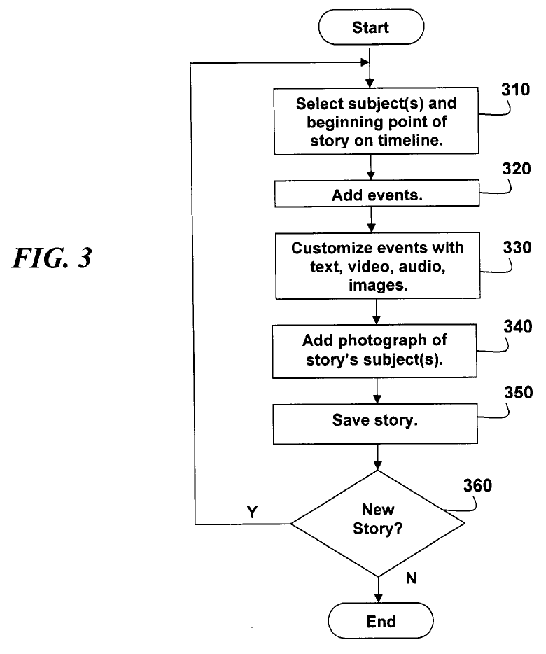

Referring to FIG. 3 there is shown a high-level flowchart summarizing the process of building or creating the story. This flowchart summarizes the process controlled by the Dashboard 104. The first step, 310, begins with the user choosing a subject or subjects on which to base the story and a beginning point for the story. The beginning point for the story is easily inserted onto the timeline by double-clicking on the timeline. The end point of the story is generated by the Dashboard 104 and defaults to the current date.

The next step, 320, is the addition of other events which make up the story. The events are also added by double-clicking on a portion of the timeline and entering the date or dates of the event and any other information about the event. The data is correlated with the chosen date or dates, since the point on the timeline can represent an event spanning more than one day, such as a vacation. The dialog boxes 106 are interview-driven, i.e., responsive to a user's selection. After the user has chosen data to correlate with the dates entered into the timeline, in step 330 the user can choose to customize these events with text, video, audio or images.

Another step in the process involves adding a photo of the subject or subjects to the Dashboard 104 in step 340. This photo would be placed in close proximity to the timeline, such that it would be obvious to an observer that the photo image is the subject of the timeline. A more detailed narrative and screenshots of this capability will be discussed later. After the user has created a story in step 350 the story is saved. Next in step 360 the user determines if he/she wants to create another story. If so, the process begins again at step 310.

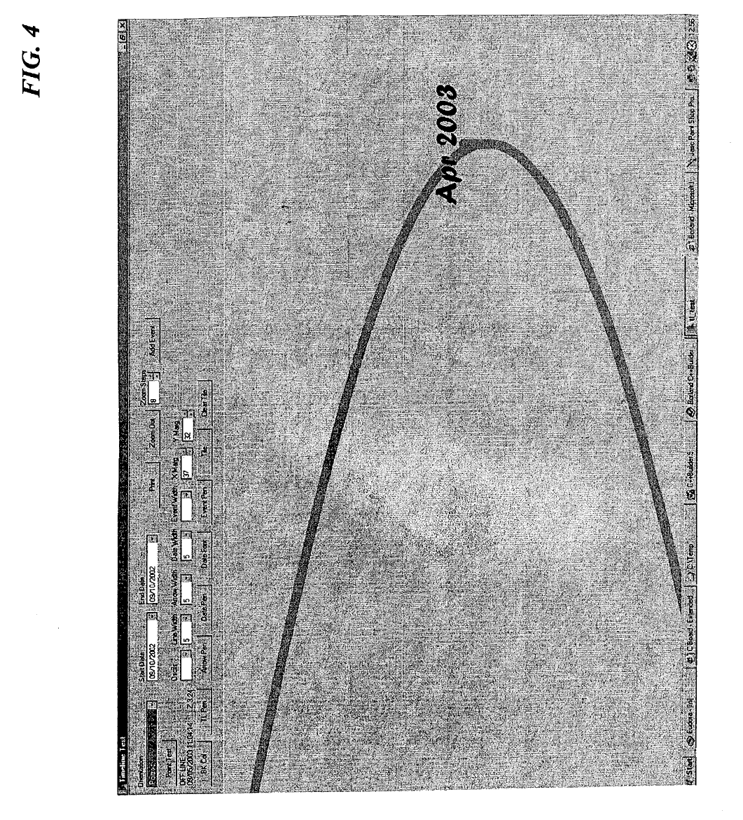

Referring to FIG. 4 there is displayed an enlarged or “zoomed-in” shot of the timeline of the Dashboard 101. This zoom feature allows for viewing over-lapping events or events which are situated in close proximity on the timeline. Events, or points on the timeline, can be one-day only or multi-day events, such as vacations, high school years, etc. Assume that the subject attended high school from 1989-1993. This would be one point on the timeline. Assume also that another event on the timeline is the subject's Junior Prom in 1992. Since the two events are over-lapping, the zoom feature allows a user to be able to distinguish between points on the line and view the “Junior Prom” event as a separate and distinct event from the “high school years” event.

As stated earlier, the Dashboard 104 creates a story in a special file format. In one embodiment of the invention, the creation of a story on the timeline involves creating a proprietary file format similar to XML (eXtensible Markup Language) in the background based on how the user interacts with the software and associates different media items, images, text, sounds, and video with events at different times along the timeline. In alternate embodiments, other file formats could be employed and still yield the same results.

Now that an overview of the process has been presented, a more detailed explanation is set forth here. In one embodiment, the Timeline Maker 101 is activated by inserting a CDROM containing the Timeline software. Alternatively, the Timeline Maker 101 could be launched by clicking on an icon displayed on a web site. When the Timeline Maker 101 is launched, the user will see the Dashboard 104 as shown in FIG. 3. Next, a dialog box 106 will pop-up introducing the “Story-Telling Wizard,” also known as the “Timewalker,” and requesting input from the user on how to proceed.

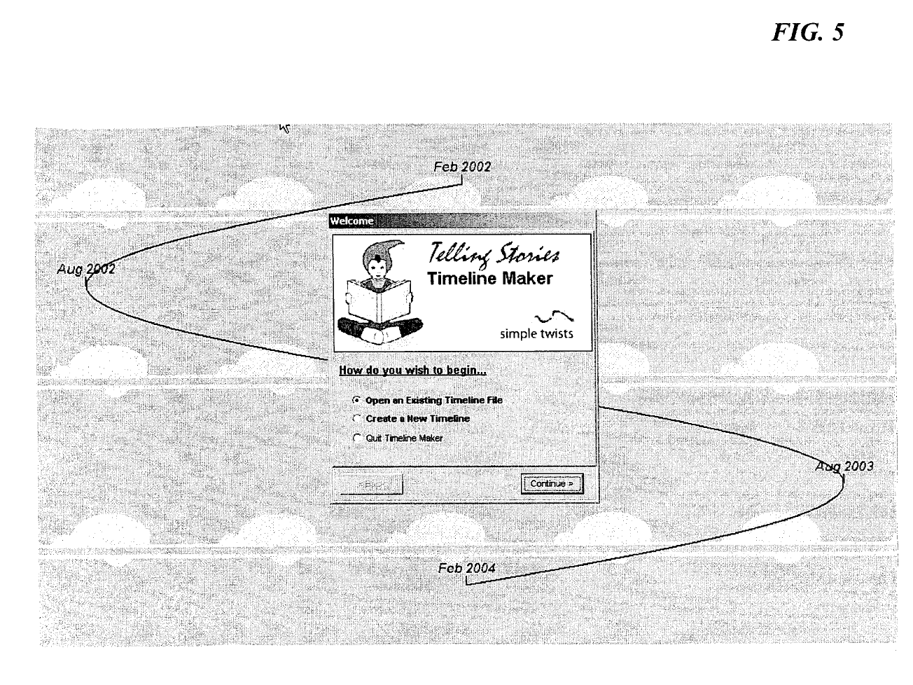

Referring to FIG. 5 there is shown one possible representation of the dialog box 106 wherein the user can select to run the Timeline Maker 101 from an already existing Timeline File 108 or create a new timeline. Alternatively, the user can choose to exit the program at this point.

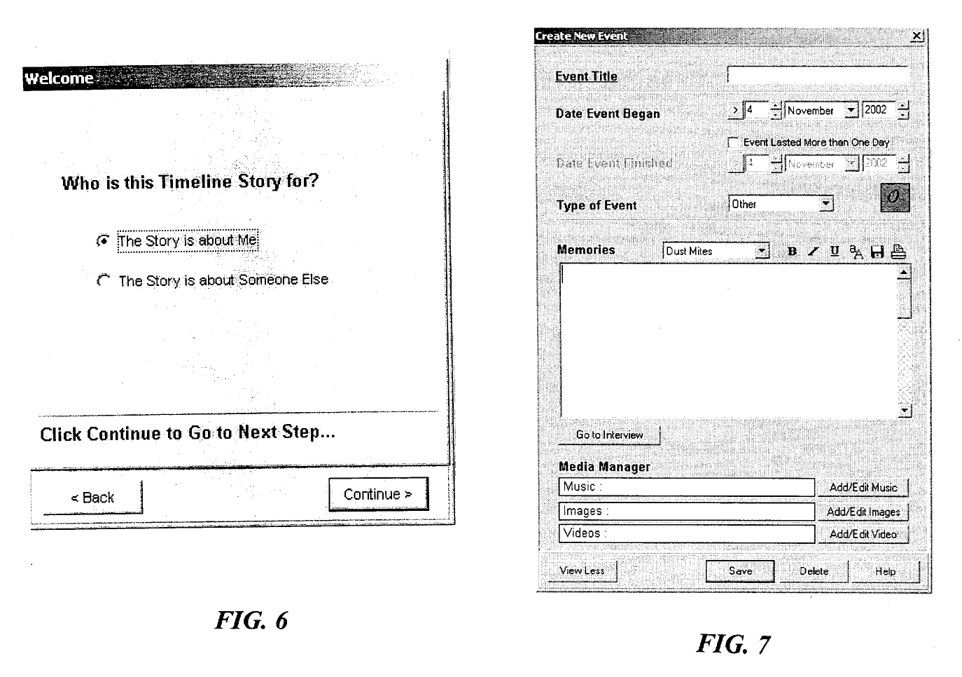

Assume that the user has chosen to create a new timeline. As stated before, the Timeline Maker 101 is interview-driven, so it will activate dialog boxes 106 which are geared for the creation of a new timeline. One such example of this processing is the “Who is the Timeline Story for?” dialog box 106 of FIG. 6. Other dialog boxes 106 will be displayed to the user in order to receive the appropriate input, according to the user's previous selections.

After some basic information about the subject of the story has been entered, the next step is for the user to choose a beginning point for the timeline. This will be the first “event” of the story. New events are easily introduced into the story in one of three ways: 1) by double-clicking any unoccupied area of the timeline on the Dashboard 104; 2) by selecting “Add new event” on the Dashboard 104 menu; or 3) by right-clicking on an occupied section of the timeline.

Once the user double-clicks on a point on the timeline a dialog box 106 pops up to allow for the date to be entered. For purposes of this discussion, assume that the subject of the timeline is a person born in the 1970s and that the user has chosen the subject's birthdate as the starting point. The current date is chosen as the end point.

According to the invention any other dates could be chosen as starting and ending points. For example, a starting point could be a wedding date or the date of inception of a company. The ending point, once chosen, can be changed. The user is not restricted to the ending point originally chosen. This flexibility allows information to be added to the timeline, thereby ensuring the ability to keep it up to date perpetually. Optionally, the date entered can be represented on the timeline in a variety of text or graphical formats. For example, for purposes of this discussion, assume that a point on the timeline represents the subject's trip to Egypt in June of 1986. The event could be represented by a stylized textual date, such as “June, 1986,” a gif (graphics interchange format) image of the Sphynx, or even hieroglyphics.

FIG. 7 shows a “Create New Event” dialog box 106 which pops up when the user proceeds in one of the three ways listed above. In this dialog box 106 the user will input some general information about the event. The Create New Event dialog box 106 will be the starting point for the addition of all events to the story.

In a preferred embodiment, as shown in FIG. 7, the Create New Event dialog box 106 comprises five sections: the Event Title, the Event Date(s), the Event Type, a Memories Box, and a Media Manager. The Event Title is the name given to that event and that name is entered in the uppermost text box provided. This name could be any name of the user's choosing, however it is assumed that a user will prefer to choose a name descriptive of an event, such as “Coronation.”

The Event Date section allows the user to choose the date or dates for the event, optionally overriding the defaulted date. Assume that a user has chosen to enter a new event by double-clicking an unoccupied spot on the timeline. When the dialog box is first displayed, the event date defaults to the date representing the selected point on the timeline which the user chose. This date can be easily changed using the pull-down menu provided. It is important to note that the order in which events appear on the timeline is guided by the event date(s), not the location where the user clicked to create the event. Therefore, once the event is created, it will appear on the timeline in the space allocated to the date chosen, not necessarily the spot where the user clicked. This ability to organize events in chronological order is an important feature of the Dashboard 104.

The third section of the dialog box 106 is the Event Type section. This represents the category for the event. For example, the user may choose to categorize an event as a Birthday or a Vacation. There are several pre-formatted event types from which to choose, such as Birth, New Job, Trip, Birthday, Romance, Death, Graduation, Historical Event, etc. Optionally, the user can add and/or delete events. In this section the user is also able to choose a color for the label, or tag, which will mark this event on the timeline, along with an icon to represent the event, such as balloons for a birthday event.

The fourth section, the Memories section, is a text box where the user can add any textual information to associate with that event. The text can be formatted in a variety of styles and colors according to user preference. Below the text box, there is a “Go to Interview” button. The “Go to Interview” button will be enabled if the selected event type has corresponding interview questions. If the user selects an event with an interview capability and then selects the “Go to Interview” button, an Interview dialog box 106 will appear with a series of questions and space provided for user input in the form of free-form text.

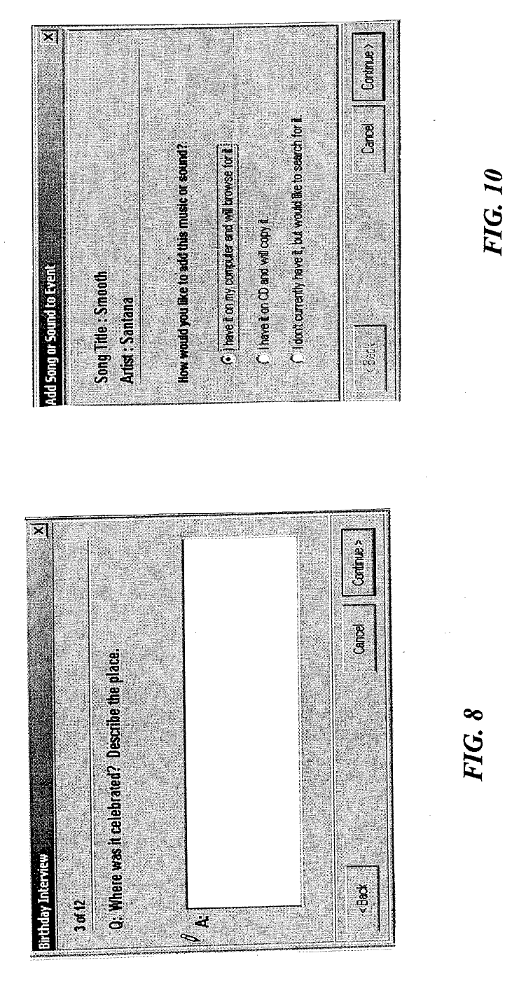

Referring to FIG. 8, the “Go to Interview” button takes the user to an interview geared specifically for the chosen event type. If there is no interview associated with the selected event type then this button is not enabled. Assume that the selected event is categorized as a “Birthday” event and the user has clicked on the “Go to Interview” button. The “interview” consists of multiple dialog boxes 106, each displaying a question related to the event. The user answers the question in the text box provided. The questions range from very general to very specific and are designed to evoke a greater recall of the details of an event. Some of the questions ask the same thing, but are worded differently in order to remind the user of a buried memory. People will often need help in recalling details of an event. Here are some sample questions for an “interview” associated with a “Birthday” event:

Which birthday is this?

Whose birthday is it?

Whose birthday is this and how old were they?

Who was at the birthday?

Where was it celebrated?

Where was it celebrated? Describe the place.

Did it take place in the afternoon or evening? What was the atmosphere? Was it inside or outside?

If yours, with whom was it celebrated?

Can you name the people who were there?

What kind of birthday cake was there?

What other food was there?

What did you drink?

Can you remember what you wore?

The questions are presented to the user in a manner which is calculated to improve the recall of past events. Questions of a general nature are interspersed with more detailed questions. The general questions set the tone for a relaxed interview, as opposed to an interrogation. The detailed questions are aimed at prodding memories which may be buried in a user's subconscious. If you look at the birthday questions above you will note that many of the questions focus on sensory recall (taste, smell, touch, etc.). Many subjects will exhibit a clearer recall of an event when prodded by a sensory question.

The fifth section, the Media Manager, is the starting point from where the user can add Sound, Images or Video to further customize an event. This is the most robust section of the Create New Event dialog box 106 and comprises three sections: 1) Music; 2) Images; and 3) Video. To add music and/or audio to an event, a user selects the “Add/Edit Music” button from the Media Manager section of the dialog box 106.

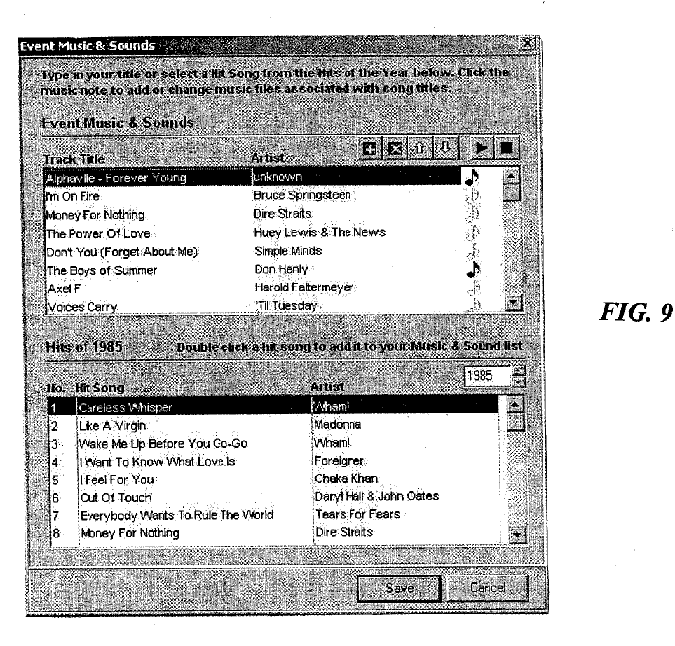

FIG. 9 shows the “Event Music and Sounds” dialog box 106 which will allow the user to choose music for the event. This box has two sections. The top section contains fields for a tract titles and artists. The bottom section contains a “hit song” list displaying hit songs from the event date. The top section is where the user adds or deletes music selections by selecting the “+” or “−” buttons. In order to add a music selection, the user will click the “+” icon, then type in the name and artist for the desired track. Alternatively, the user could highlight a track from the scroll-down list, double-click on it and it would appear in the top section. The user can also listen to the selected tracks by selecting the “play” button, represented as “ [symbol] ”. Displaying hit songs from an event year is one of many easy-to-use customizations built into the system. Next to each track added in the top section, the user will see a musical note displayed. If the musical note next to the track is a full note “ [symbol] ” this indicates that there is media already associated with this track. An empty note indicates that there is no media associated. Clicking on the note launches another dialog box 106, described below.

FIG. 10 shows the “Add Song or Sound to Event” dialog box 106 which is launched by clicking the musical note next to the song in the Event Music and Sounds box of FIG. 9. This box 106 presents three choices to the user for retrieving the music: 1) retrieving the music from the computer; 2) copying it from a CD; or 3) searching for it on the Internet. If the media has already been associated but the user is editing its location, then this dialog box 106 will read “Edit Song or Sound.”

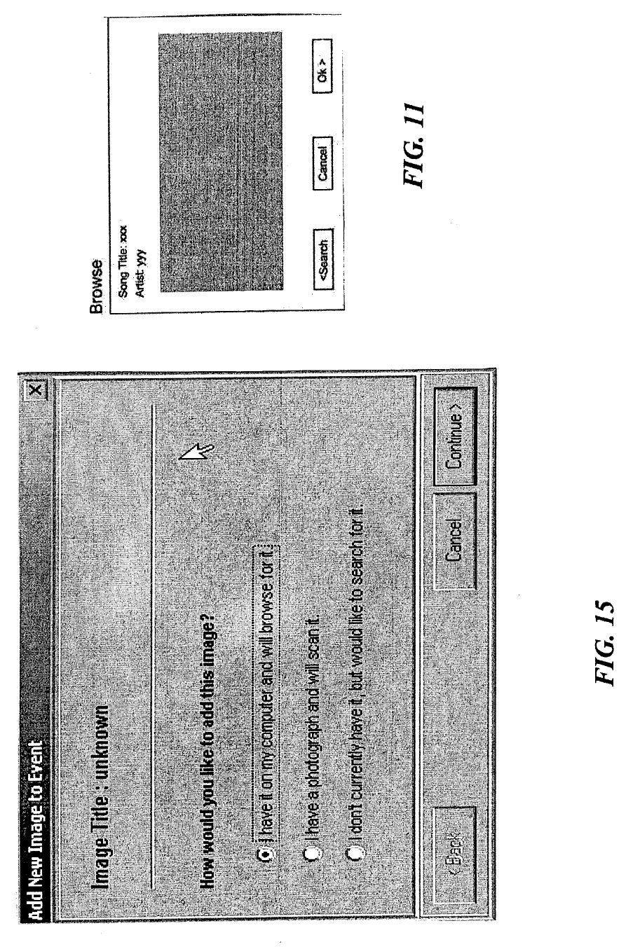

FIG. 11 shows the “Browse” box which will appear if the user chose “retrieve music from my computer” in the previous dialog box of FIG. 10. The Browse box allows a user to search for an item using a drop-down list displaying contents.

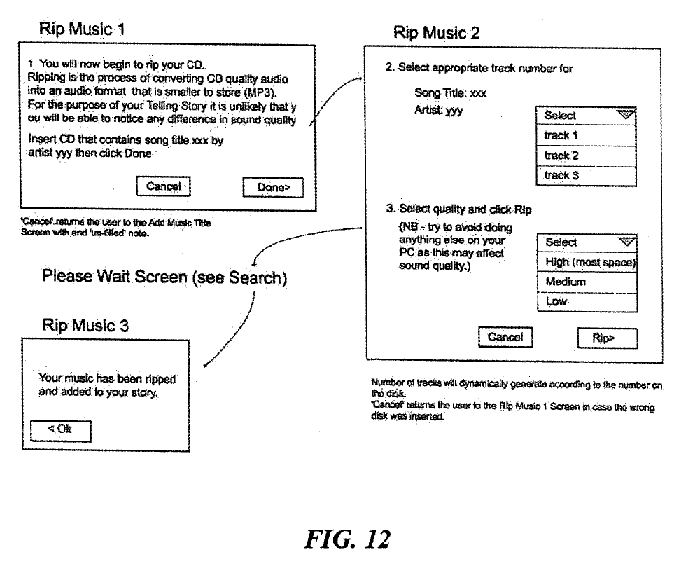

FIG. 12 illustrates the process of “ripping” a CD in order to add music to an event. Ripping a CD involves extracting the digital data from a music CD and converting the data into an MP3 format which can be played on a computer. MP3 is easier to transmit because it is compressed. FIG. 12 features three dialog boxes 106 which appear in sequence in response to the user choosing to copy music from a CD in the dialog box 106 of FIG. 10. The process of FIG. 12 exemplifies the user-friendly feature of the Timeline Maker 101 as it transforms a sophisticated process such as ripping CDs into a simple point-and-click function.

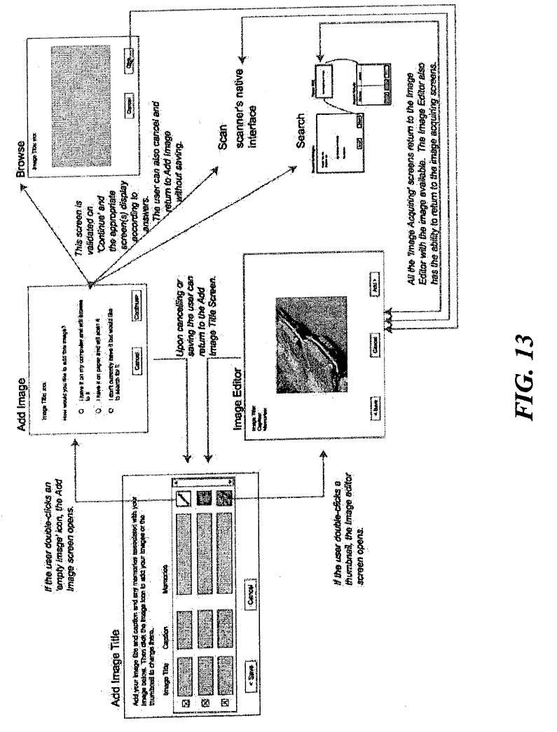

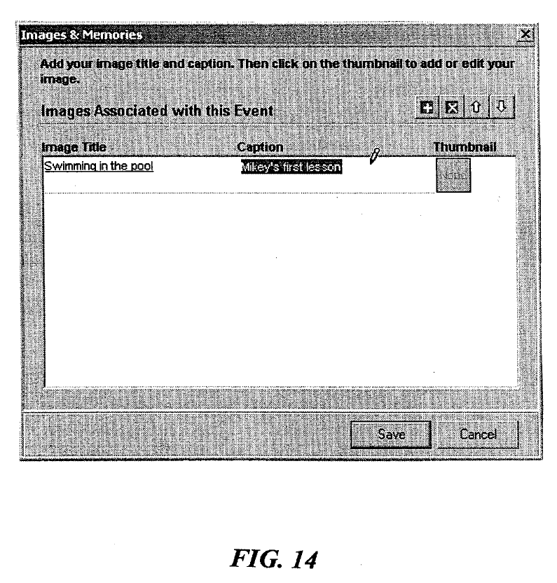

Adding images such as photographs is another way to further enhance and customize a story. FIG. 13 shows a representation of the process of selecting an image for the timeline story. To add images a user selects the “Add/Edit Images” button from the Media Manager section of the dialog box 106. This brings up the “Images and Memories” dialog box 106 shown in FIG. 14. To begin, the user selects a title for the chosen image and a caption which will appear beneath the image. The user can also choose to enter memories about an image in the free text field. Next, the user clicks on the thumbnail icon to the right of the caption. This will bring up the “Add New Image to Event” box as shown in FIG. 15. Just as in the “Add Song or Sound to Event” box of FIG. 10, the user has three choices for retrieving images: 1) retrieving an image from the computer; 2) scanning the image; or 3) searching for it on the Internet. Recall the example of the screenplay writer. The writer would select the second option, scanning the image, to scan a scene sketch.

Another way a user can add images to the timeline is to read in a media file (such as a JPEG). The Dashboard 104 reads the file information (called “exif”) in the JPEG file. This exif contains the date stamp originally entered by the camera. The Dashboard 104 reads this date stamp and automatically inserts the image into the appropriate point on the timeline.

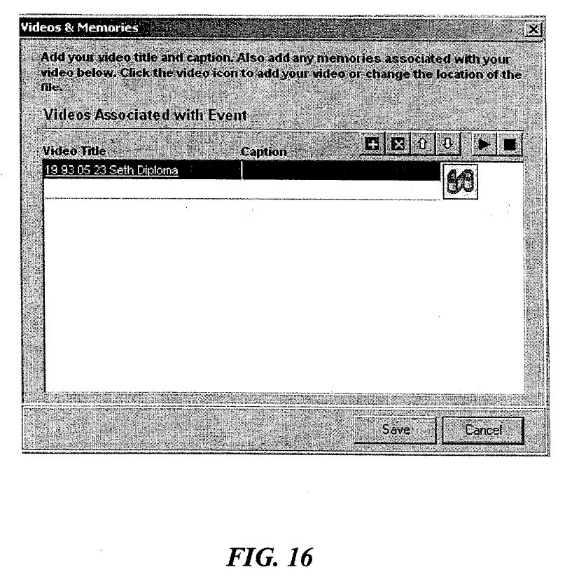

Adding video to enhance the story is the third option in the “Media Manager” section of the dialog box 106. When the user selects the “Add/Edit Video” button, the “Videos and Memories” box 106, as shown in FIG. 16, appears. Selecting video proceeds along the same lines as selecting images. First, select a title and caption for the video, then click on the thumbnail icon to the right of the caption. This activates the “Add Video to Event” box 106 which is similar to the Add New Images to Event box shown in FIG. 15. This box presents two choices for selecting a video: 1) retrieving a video from the computer; or 2) searching for a video on the Internet. Just as in the music selection box, there is a feature for previewing the video simply by clicking on the “play” symbol “ [symbol] ”

An important feature of the Dashboard 104 is its robust editing capabilities. The Dashboard 104 is able to edit or modify the audio, video and image selections retrieved. This is easily accomplished by clicking on the thumbnail icon to the right of the selection.

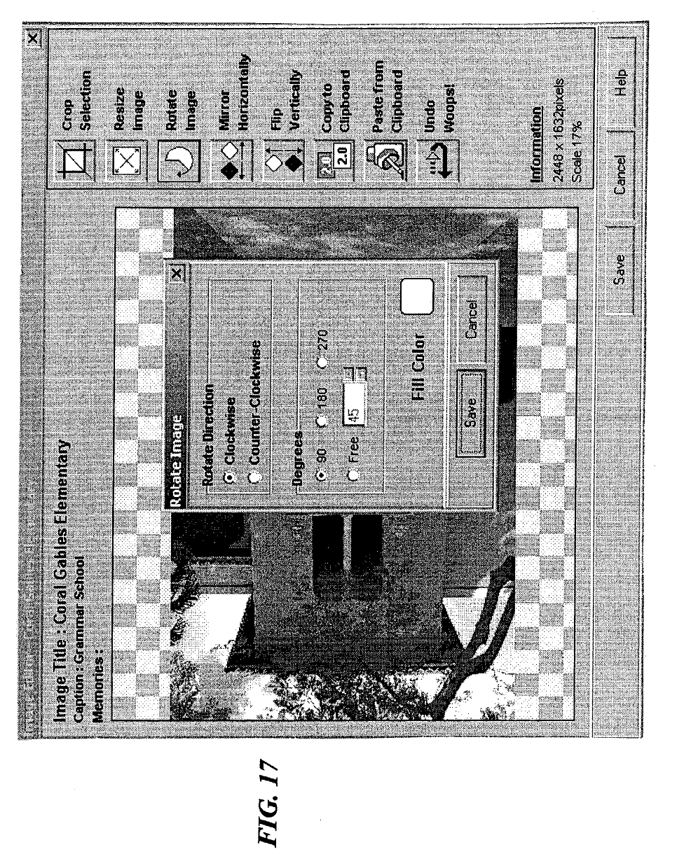

FIG. 17 illustrates an example of the Image Editor dialog box 106. This box 106 presents the image on the left-hand side, along with the Image Title, Caption, and any Memories. The right-hand side of the box 106 contains various editing tools useful for modifying the image. These include: cropping, resizing, adjusting brightness and contrast (both automatically and manually), rotating, flipping the image horizontally, flipping the image vertically, rotating an image, red-eye reduction, etc. An image can also be copied from a clipboard and edited here.

Editing video proceeds along the same lines as editing images, by clicking on the thumbnail icon to the right of the video selection. Then, the Video Editor dialog box 106 will appear. This dialog box 106 is similar to the Image Editor dialog box 106 of FIG. 17. The thumbnail icons for the Video Editor are presented as movie cameras instead of musical notes. Video editing includes cutting a video clip down to a desired video sequence. Additionally, it includes cutting two or more vide clips together to create a smooth transition such that the second video clip starts where the first leaves off without showing any dead space in between. Video transitions such as “fade” and “wipe” could also be added. The user can also play the video selection from this dialog box 106 as a preview.

Editing audio, such as voice-overs and music, is done through the Music Editor Dialog Box 106, which is similar to the Image Editor of FIG. 17 and the Video Editor dialog box 106. Audio editing includes cutting an audio track and fading from a positive volume to zero volume. Two channels of audio can be edited: a voiceover channel and a music channel. Additionally, audio editing includes cutting two or more songs together to create a smooth transition such that the second song picks up where the first song ends without any quiet between the two songs. A user can also listen to the selected audio from this dialog box 106 as a preview.

Most of the dialog boxes 106 have the following buttons which will be described here. A “Save” button is for saving the data entered and an “Exit” button is to allow the user to go directly back to the timeline on the Dashboard 104. There is also a “Cancel” button to cancel any choices made and go back to the previous dialog box 106 or back to the timeline.

Another feature of the Timeline Maker 101 is the ability to create a story with minimal user input, by using pre-selected defaults. This is the easiest and quickest way to create a story using the Dashboard 104. To proceed in this manner, a user simply answers three questions when the program starts. The questions are similar to the following: “Is this timeline for you or someone else?” “What is the name of the subject of this timeline?” and “Is the subject male, female, or neither?” Once the user answers those questions and then chooses a start date for the timeline, the rest of the timeline can be created with pre-selected defaults. Historical events will automatically be added to the timeline within the time span provided. In addition, the Dashboard 104 automatically inserts events for any appropriate milestone birthdays. For example, if the subject is 43 years old, the Dashboard 104 will create “Birthday” events for the subject's 18^{th}, 21^{st}, 30^{th} and 40^{th} birthdays. A user who is pressed for time or does not have the subject information readily available can quickly create a story with minimal input in this manner and then later retrieve the story and add to it; or, alternatively, pass the story to another person to enhance it.

This brings us to another feature of the Timeline Maker 101. Existing events can be easily modified. Double-clicking existing events opens the “Modify Event” dialog box 106. This dialog box is identical to the “Create New Event” box of FIG. 7 with the exception of the title; therefore we will refer to the dialog box of FIG. 7 to represent both dialog boxes. The “Modify Event” dialog box 106 allows the editing of data previously entered as well as the addition or deletion of data. Events can also be deleted by selecting the “Delete Event” button in the Modify Event dialog box 106.

Production Generator

Assume that a user has completed a timeline story and, since telling a story is a natural progression from creating a story, assume that the user will want to output the story for display. Screenplay writers and authors need to be able to not only tell a story, but actually create, or build, the story, and then promote and sell that story, perhaps to a publishing company or studio executive. This is easily accomplished with the Production Generator 120. The Production Generator 120 will output the story for final display in one of several formats. Four possible formats are listed here, while other formats could be contemplated in keeping with the spirit of the invention:

1. a presentation for an audience, such as a slide or video presentation;

2. a Web-enabled display using HTML;

3. printed output on paper (various paper sizes will be accommodated);

4. an E-Book, or other device for the electronic display of data.

It should be remembered that in one embodiment of the invention the Timeline Maker 101 creates a story in a special file format. The Production Generator 120 is a different program which retrieves the timeline story file 108 and saves it in a presentation format. This format can then be customized for display by the user. Some key features of the Production Generator 120 are:

auto-generating a presentation format based on the media elements received;

automatically advancing from slide to slide;

adding and deleting slides and changing the default slide order;

user can configure individual slides with the number of images;

user can add a voice-over;

user can configure music—when two consecutive slides have the same music the music will continue rather than repeat from the beginning;

user can export presentation to an executable format (or pdf if print format is selected); and

backgrounds can be chosen based on the event.

One way to characterize the Production Generator 120 would be a cross between a multimedia slideshow and a movie. The story created by the Timeline Maker 101 can be “told” or presented by the Production Generator 120 in different formats, as detailed above, but for purposes of this discussion we will focus on a slide presentation example. In one embodiment, a user clicks on the Production Generator 120 icon on the computer desktop to launch the Production Generator 120.

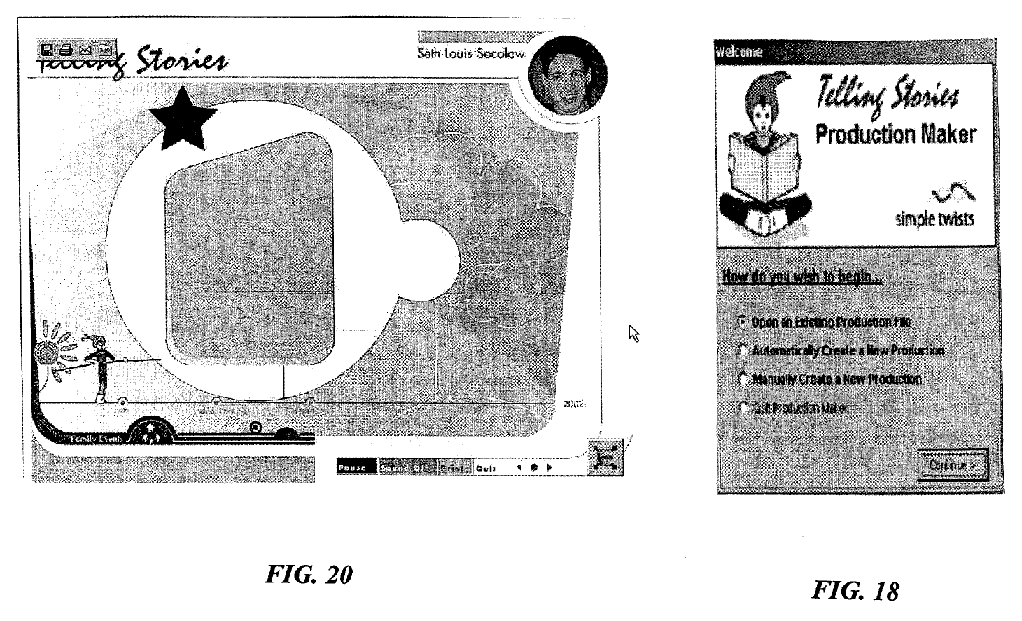

FIG. 18 shows the Production Generator 120 “Welcome” wizard (the Timewalker) which is the user's first interaction with the Production Generator 120. In this screen the user is presented with three choices for initiating the slide presentation:

1. opening an existing production file;

2. automatically creating a new production (using defaults); or

3. manually creating a new production.

Once a choice is made by selecting one of the three options above, the user will begin creating a timeline production. Alternatively, the user may choose to exit the Production Generator 120.

Referring to FIG. 18, the first choice, opening an existing production file, will open a previously created slide presentation and allow modifications. The second choice, automatically creating a new production, will generate a default slide show presentation from the Timeline File 108 without requiring any additional customizations. This is a very powerful feature because the default presentation will incorporate all of the multimedia products originally chosen and “play” them in concert with the appropriate slides in chronological order. The slides are automatically generated with captions, appropriate backgrounds and any selected images, audio and/or video.

The Production Generator 120 in the auto mode will create the appropriate format for the presentation based on the media input. For example, if an event has one image associated with it, the Production Generator 120 will use a slide template for a single photo. For an event with multiple images, a template for multiple images would be used. If an event contains both audio and video, the slide will be formatted so that the audio plays over the video for the duration of the slide. The duration of the slide will also be automatically adjusted to accommodate the media. Although this default feature is sufficient to create a robust multimedia slide presentation, assume that a user wishes to further customize the slide presentation. In this case, the user would select the third choice, manually creating a new production. This selection affords the user the most flexibility in customizing a production.

A preferred method for creating a presentation is the method wherein a user first creates a presentation automatically by accepting the default selections, and then at a later point customizes the presentation. Creating a default presentation has two advantages: 1) it can be done quickly; and 2) it gives the user a presentation outline, or template, which can then be modified over time. Just as writers often start with an outline of a story before writing it in final form, a producer would start with an outline of a presentation and then fill in the details.

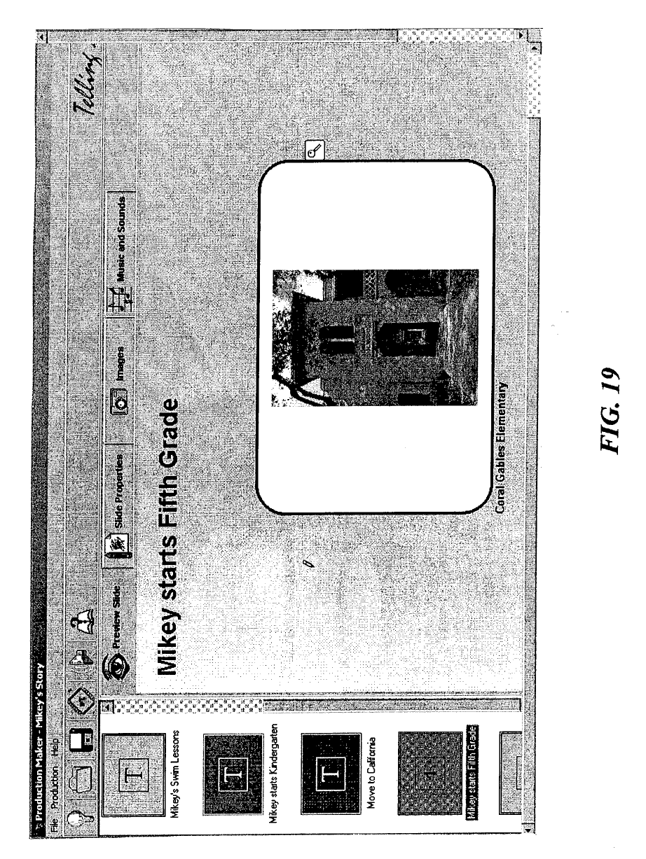

FIG. 19 shows an example of one possible embodiment for the Production Generator 120 main user interface. This interface will be the primary vehicle from which the user creates and/or customizes a slide presentation. The events created by the Timeline Maker 101 are now represented as slides on the left-hand side of the display. These slides can be customized in the Production Generator 120 as easily as the events are customized in the Timeline Maker 101. When the Production Generator 120 transforms the events from the Timeline File 108 into slides for the Output File 170, it will automatically choose a background for each slide which corresponds to the type of event which the slide represents. This ability to identify a slide by event type and distinguish it from other slides is a novel departure from the current popular presentation software which uses the same template as a background for all of the slides in a presentation.

The Production Generator 120 is also able to identify what, if any, media are associated with an event and then display the appropriate interface components for that event. For example, note that the main user interface of FIG. 19 displays a slide which has an image. The selection tabs at the top of the interface display of FIG. 19 include an Images tab. If the event selected had a video associated with it instead of an image, then the Video tab would be visible and available for selection instead.

The ordering of the slides will default to chronological order, paralleling the ordering of the events on the timeline. This ordering could be modified by the user, if desired. A user may choose to group all slides about Birthdays, for example.

FIG. 20 shows another possible embodiment for the main user interface, wherein the progression of the story from event to event is represented by the Timewalker wizard “walking” through events on the timeline. The Timewalker could be moved from event to event by the user (using the mouse) or it would step through the events as they appear on the screen. In the automatic advance mode, the Timewalker would launch the next slide by walking to the event. The Timewalker could be moved backwards as well as forwards, allowing the ability to present events out of order.

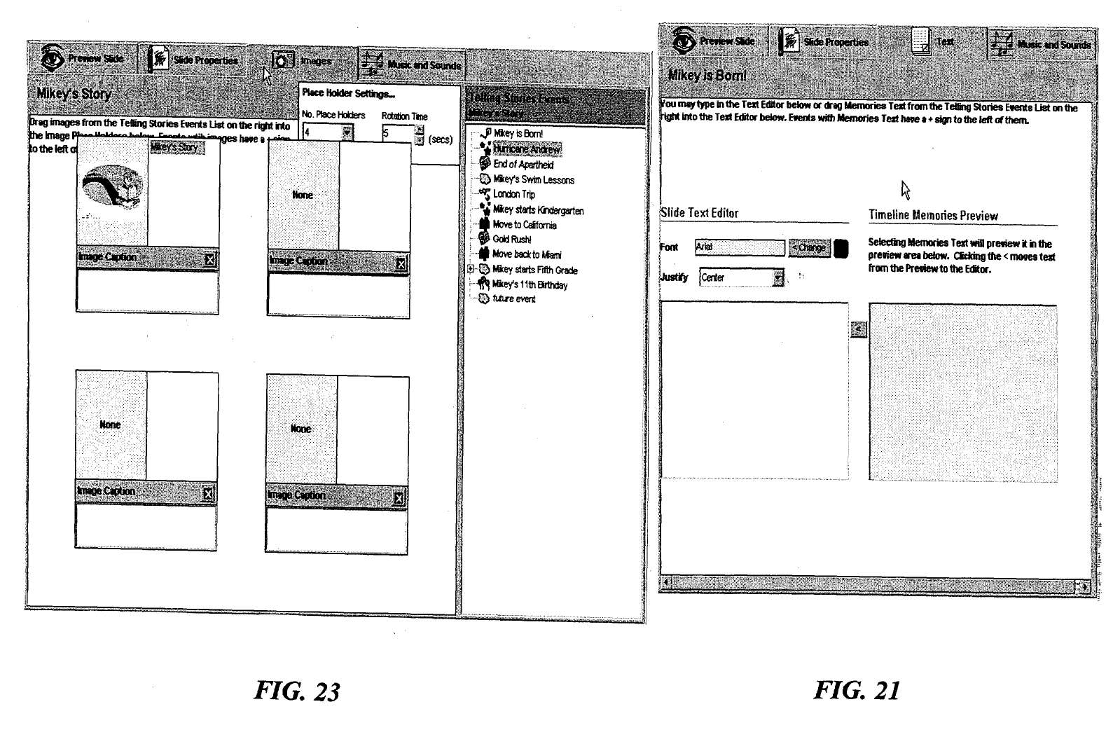

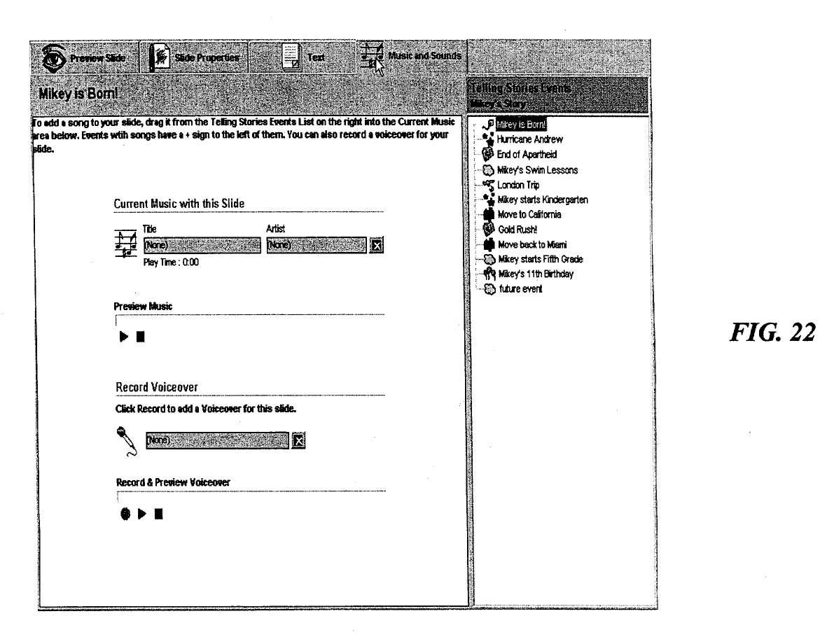

There are many different ways to customize the slide presentation. The text could be modified through the Text Editor interface of the Production Generator 120 as shown in FIG. 21. FIG. 22 shows the Music Editor interface of the Production Generator 120 for modifying music and other audio enhancements. Here the audio could be configured to play over more than one slide. This is a unique feature of the Production Generator 120. For example, a voice-over monologue could span several slides. Likewise a song could play through more than one slide. A user could select music for a group of slides and additionally record a voice-over which would play over the music. Multiple songs or song segments could be cut in together so that they play, one after the other, with no quiet between the songs or song segments. The music would be played seamlessly over the duration of one slide or multiple slides.

Likewise, FIG. 23 displays the Images Editor interface of the Production Generator 120 for modifying photographic images. As can be seen, there are many options available for editing images, such as crop, rotate and zoom.

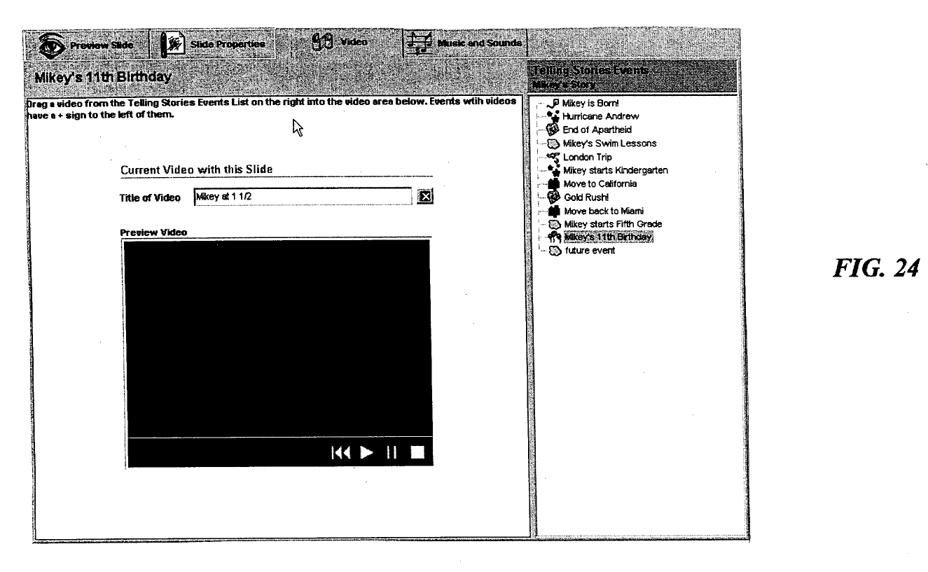

FIG. 24 displays the Video Editor interface of the Production Generator 120 for selecting and previewing a video for the slide. This interface displays the events from the Timeline File 108 on the right-hand side and the video selection and preview box on the left-hand side. The events which have video associated with them display a plus sign next to them. To select a video associated with an event, a user would simply click on the plus sign to view the video selection and then drag and drop the selected video on the left-hand side of the interface. Multiple video clips could be chosen to play seamlessly one after the other, with one clip starting right where the previous one ends. The video clips could be selected to appear during the duration of one slide or spanning multiple slides.

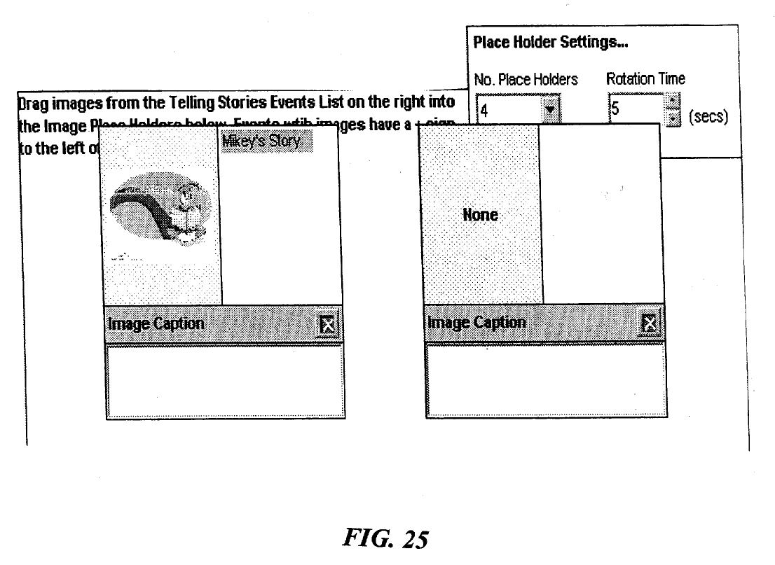

Another unique feature of the Production Generator 120 is the ability to show multiple images on one slide. Refer to FIG. 25 which shows a close-up view of the Place Holder Settings box of the Images Editor interface of FIG. 23. This feature is available on any slides containing more than one image. The Place Holder Settings box allows the user to indicate how many images will be shown on a slide and also allows the user to select the rotation time for the images. The rotation time is the number of seconds each image will appear before the Production Generator 120 advances to the next image.

The Production Generator 120 has two modes in which it can present the slides: 1) step mode; or 2) automatic advance mode. In step mode, the Production Generator 120 activates and presents slides in response to a user's prompt. This prompt could be the user clicking on the slide icon, or the user selecting a “next” button, or some other prompt, such as a voice command. Alternatively, in automatic advance mode, the Production Generator 120 will output, or present, each slide automatically without any user prompting. The slides will be presented in the order in which they appear on the main user interface. The Production Generator 120 will pause for a predetermined amount of time for each slide. A completely automatic, hands-free presentation can be made in this manner. And, since the Production Generator 120 allows the user to record a voice-over which can span over several slides, this eliminates the need for a narrator. The combination of the automatic advance feature and the voice-over flexibility make this an ideal medium for a school class presentation. An instructor could simply set up the audio-visual equipment and launch the Timeline wizard and allow the Production Generator 120 to give the presentation.

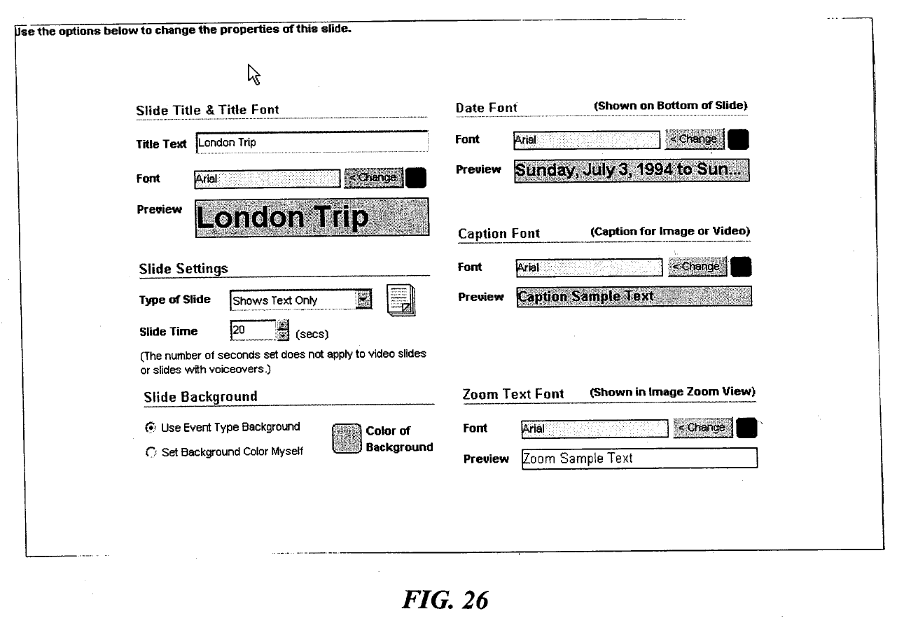

Referring to FIG. 26 is shown a Slide Properties editing interface. This highlights the editing capabilities of the Production Generator 120. Through this interface, each and every slide can be edited in several ways. First of all, the slide title can be edited and the font format for the title can be edited as well. A preview box displays how the title will appear, based on the selections. The type of slide and the number of seconds the slide will appear can also be modified. The slide background, which defaults to a background corresponding to the event type, can also be modified and previewed. The date and caption fonts can be formatted, as well as the zoom text font.

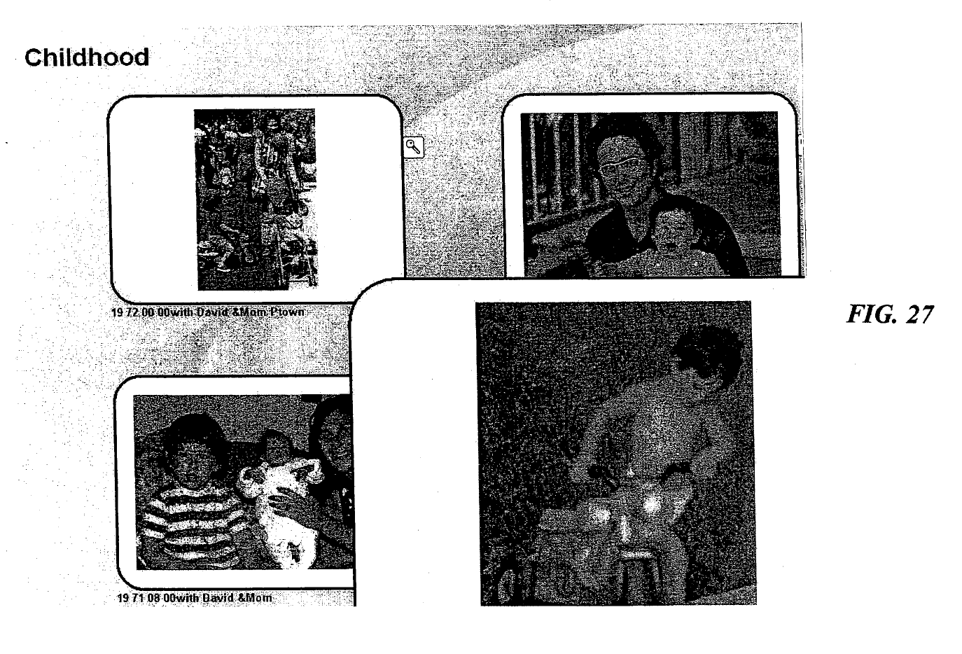

FIG. 27 shows an example of the zoom-on feature of the Production Generator 120. There are four images on this slide. The image at the lower right-hand corner has been zoomed and appears in close-up whereas the other three images are shown normal size.

As stated earlier, a user could choose to automatically create a production, or manually create a production. Automatically creating a production is the easiest and quickest way to create a production. The Production Generator 120 uses the Timeline File 108 as input and transforms the events into slides. The media associated with each event is also appended to the slides. A production created in this manner can be run without any further user input. Optionally, the user could choose to modify and further customize the slides, as presented above. Manually creating a production requires more input from the user.

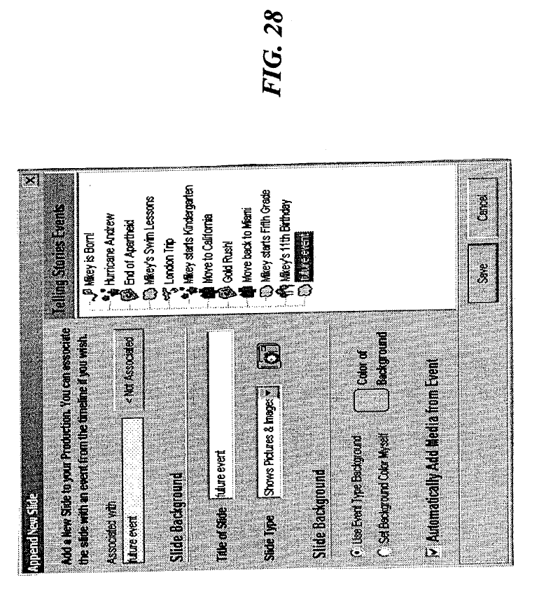

FIG. 28 shows the Append New Slide interface, used for manually creating a production. A list of events from the Timeline File 108 is displayed on the right-hand side. Adding a slide from an event can be done by double-clicking on a listed event. The event will appear in the text box.

If the user selects a slide associated with an event from the Timeline File 108, then the title, slide type, and slide background information appear as defaults. These attributes can be modified, if desired. A checkbox appears at the bottom of the dialog box. If the box is checked, media associated with the event will be appended to the slide.

The invention can be embodied as an ASP (Application Service Provider). In that embodiment, an organization that hosts software applications on its own servers within its own facilities provides access to users or subscribers to create productions, store the products and perform the productions from its server. All that the user would require is a client-side interface to the ASP server. Such an interface could simply be a commercially-available browser such as Microsoft Explorer™. Given the advent of the Web browser as the universal client interface, the ASP market is expected to grow rapidly.

In yet another embodiment, a user could employ an Active Server Page, a Web server technology from Microsoft that allows for the creation of dynamic, interactive sessions with the user. An Active Server Page is a Web page that contains HTML and embedded programming code written in VBScript or Jscript. Active Server Pages allow Web pages to interact with databases and other programs. Third-party products add Active Server Page capability to non-Microsoft Web servers. The Active Server Page technology is an ISAPI program and ASP documents use an ASP extension.

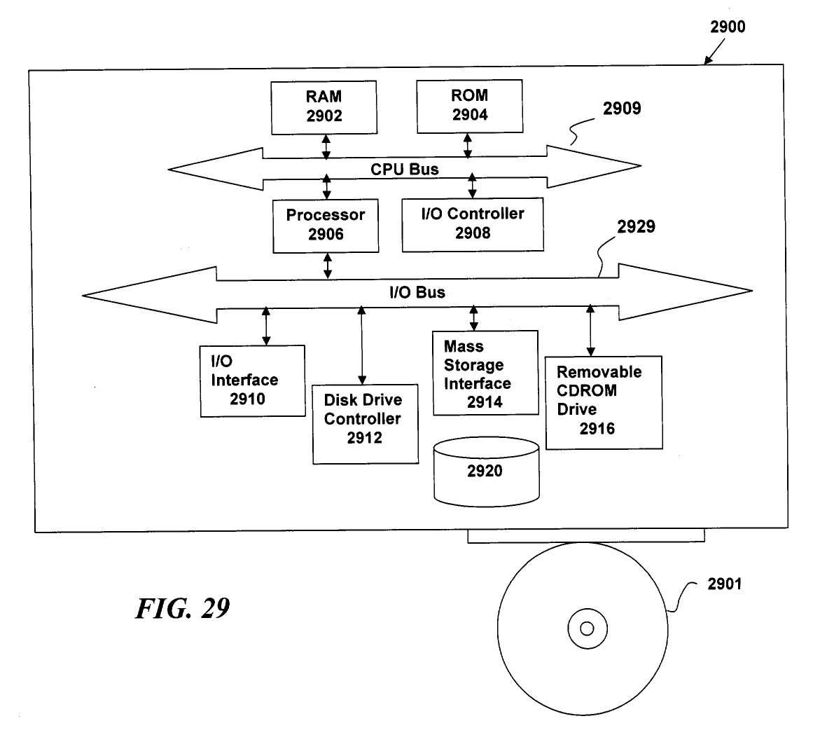

FIG. 29 is a simplified block diagram of a programmable computer that can be configured to operate according to an embodiment of the invention. According to an embodiment of the invention, a computer readable medium, such as a CDROM 2901 can include program instructions for operating the programmable computer 2900 according to the invention. The processing apparatus of the programmable computer 2900 comprises: random access memory 2902, read-only memory 2904, a processor 2906 and input/output controller 2908. These are linked by a CPU bus 2909. Additionally, there is an input/output bus 2929, and input/output interface 2910, a disk drive controller 2912, a mass storage device 2920, a mass storage interface 2914, and a removable CDROM drive 2916. What has been shown and discussed is a highly-simplified depiction of a programmable computer apparatus. Those skilled in the art will appreciate that other low-level components and connections are required in any practical application of a computer apparatus.

The invention can also be embodied as a set of program instructions and related data in a software CD. Another possible embodiment of this invention would be as software “bundled” with other software products and sold as a single unit.

Therefore, while there have been described what are presently considered to be preferred embodiments, it will be understood by those skilled in the art that other modifications can be made within the spirit of the invention.

We claim:

1. A method for creating a production of a story, comprising the steps of:
displaying a screen comprising a representation of a timeline relating to a story wherein the representation comprises a plurality of points, each for representing an event;
receiving information relating to at least one event and a time associated with the event;
storing the received information in association with the at least one event; and
linking the information to at least one point in the representation such that a user can retrieve the information by selecting the at least one point.

2. The method of claim 1 wherein the receiving step further comprises displaying a graphical and text screen for entering information on that screen.

3. The method of claim 4 wherein the graphical and text screen comprises displaying a prompt for adding information to the story.

4. The method of claim 4 wherein the graphical and text screen comprises displaying a choice for deleting information from the story.

5. The method of claim 1 wherein the receiving step comprises receiving an identification of a point on the timeline as a beginning point for the story.

6. The method of claim 5 wherein the receiving step further comprises receiving an identification of a point on the timeline as an end point for the story.

7. The method of claim 1 further comprising receiving digital images for storage and linking with at least one event.

8. The method of claim 7 further comprising displaying the digital images in proximity to the timeline.

9. The method of claim 1 further comprising receiving scanned images for storage and linking with at least one event.

10. The method of claim 1 further comprising receiving text and images from the Internet for storage and linking with at least one event

11. The method of claim 1 wherein the displaying step comprises displaying a device for prompting the user to open a new story.

12. The method of claim 1 further comprising the step of:
merging two or more timelines into one story by choosing a point representing a time where the two or more timelines intersect.

13. The method of claim 1 wherein the receiving step further comprises guiding the user through a series of text and graphical displays responsive to a user's selection.

14. The method of claim 1 wherein the receiving step further comprises prompting the user with a series of questions responsive to the user's selection.

15. The method of claim 1 further comprising displaying an enlarged image of the timeline, responsive to a user command.

16. A method comprising:
creating a production using a timeline file; and
presenting the production according to the timeline file.

17. The method of claim 16 further comprising a step of presenting a user with a set of selectable events for including in the production.

18. The method of claim 17 further comprising a step of receiving a selection from the user, the selection comprising a set of selected events for including in the production.

19. The method of claim 16 further comprising the steps of:
receiving a user command to rotate a displayed image into a plurality of placeholders; and
displaying the image rotating into a plurality of placeholders, responsive to the user command.

20. The method of claim 16 further comprising a step of displaying a plurality of slides each representing at least part of an event.

21. The method of claim 20 further comprising a step of playing a single song while displaying all of the slides.

22. The method of claim 21 further comprising a step of playing a voice-over while playing the song.

23. A computer readable medium comprising program instructions for creating a production of a story, comprising instructions for:
displaying a screen comprising a representation of a timeline relating to a story wherein the representation comprises a plurality of points, each for representing an event;
receiving information relating to at least one event and a time associated with the event;
storing the received information in association with the at least one event; and
linking the information to at least one point in the representation such that a user can retrieve the information by selecting the at least one point.

24. The computer readable medium of claim 23, further comprising program instructions for:
creating a production using a timeline file; and
presenting the production according to the timeline file.

25. A production generator comprising:
an image editor;
an audio editor;
a video editor and
a text editor, all integrated for generating a multimedia production;
wherein the image editor comprises means for cropping an image;
resizing the image; rotating the image; mirroring an image horizontally, flipping an image vertically; removing red-eyes from a digital photograph; auto adjusting the brightness and contrast of a picture; manually adjusting the brightness of a picture, manually adjusting the contrast of a picture;
wherein the audio editor comprises means for: editing two or more channels of audio with a voiceover channel and a music channel;
wherein the video editor comprises means for cutting a video clip down to a desired video sequence; and
wherein the text editor comprises means for changing text fonts, text colors, background colors, and alignment.

26. The production generator of claim 25 wherein the audio editor comprises means for cutting a plurality of songs together such that a second song seamlessly commences where a first song ended.

27. The production generator of claim 25 wherein the video editor further comprises means for seamlessly cutting a plurality of video clips together.

28. The production generator of claim 25 wherein the video editor further comprises means for creating transitions comprising a fading effect.

29. The production generator of claim 25 wherein the video editor further comprises means for creating transitions comprising a wiping effect.

30. A production generator comprising:
an input for receiving a plurality of multimedia production components; and
an integrator for integrating the plurality of multimedia production components received into a production for display;
the integrator comprising adaptive means for automatically generating a production adapted to the plurality of multimedia production components received so that each of the plurality of multimedia production components received is used in the production.

31. The production generator of claim 30 wherein the integrator comprises means for recognizing a type of event from user selections and adapting the production to the type of event.

32. The production generator of claim 31 wherein the means for recognizing a type of event comprises means for receiving an indication of the type of the event to be portrayed in the production.

33. The production generator of claim 31 comprising a plurality of templates comprising pre-selected multimedia components for including in the production based on the type of event to be portrayed in the production.

34. The production generator of claim 30 further comprising a receiver for receiving a file of date stamped images; and means for inserting the date stamped images into the production according to their respective date stamps.
